(19) United States
(12) Patent Application Publication
(10) Pub. No.: US 2016/0267834 A1
(43) Pub. Date: Sep. 15, 2016

(54) DISPLAY DIODE RELATIVE AGE

(71) Applicant: Microsoft Technology Licensing, LLC, Redmond, WA (US)

(72) Inventors: Ying ZHENG, Redmond, WA (US); Jiandong HUANG, Bellevue, WA (US); Andrew N. CADY, Kirkland, WA (US); Steven N. BATHICHE, Kirkland, WA (US); Rajesh Manohar DIGHDE, Redmond, WA (US); Xiaoyan HU, Redmond, WA (US)

(73) Assignee: MICROSOFT TECHNOLOGY LICENSING, LLC, Redmond, WA (US)

(21) Appl. No.: 14/656,664

(22) Filed: Mar. 12, 2015

(51) Int. Cl. G09G 3/32

(52) U.S. Cl. CPC G09G 3/32; G09G 2320/045

(57) ABSTRACT

The description relates to display device image quality. One example can include a display, a processor, storage, a pixel run time counter, and a pixel effective age compensation component. The display can include multiple pixels. Individual pixels can include multiple different colored light emitting diodes (LEDs). The processor can be configured to convert image related data into frame renderings for driving the multiple pixels of the display. The pixel run time counter can be configured to store pixel information on the storage that reflects time and intensity parameters at which the frame renderings have driven the multiple color LEDs of the individual pixels in the frame renderings. The frame compensation component can be configured to receive a new frame rendering and to generate an adjusted frame rendering that compensates for luminance degradation of individual pixels based at least upon the stored pixel information.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the FIG. and associated discussion where the reference number is first introduced.

FIG. 1 shows a display diode use case scenario example in accordance with some implementations of the present concepts.

FIG. 2 shows a system example in accordance with some implementations of the present concepts.

FIGS. 3-4 show visual content processing pipeline examples in accordance with some implementations of the present concepts.

FIGS. 5-7 show example flowcharts in accordance with some implementations of the present concepts.

### DESCRIPTION

Current light emitting diode (LED) displays can suffer from image degradation due to operational aging (e.g., performance degradation) of the light emitting materials (e.g., irreversible decrease of luminance with operation time) and/or screen burn in (e.g., different intensity of image across pixels). Moreover, different colors of LEDs, such as red, green, and blue emitting materials have different aging speed. The present implementations can track this degradation and compensate for the degradation to reduce performance loss of the display as it ages from use (e.g., performance degrades). The compensation can address multiple performance aspects, such as pixel to pixel illumination intensity and/or pixel image quality parameters, such as pixel color.

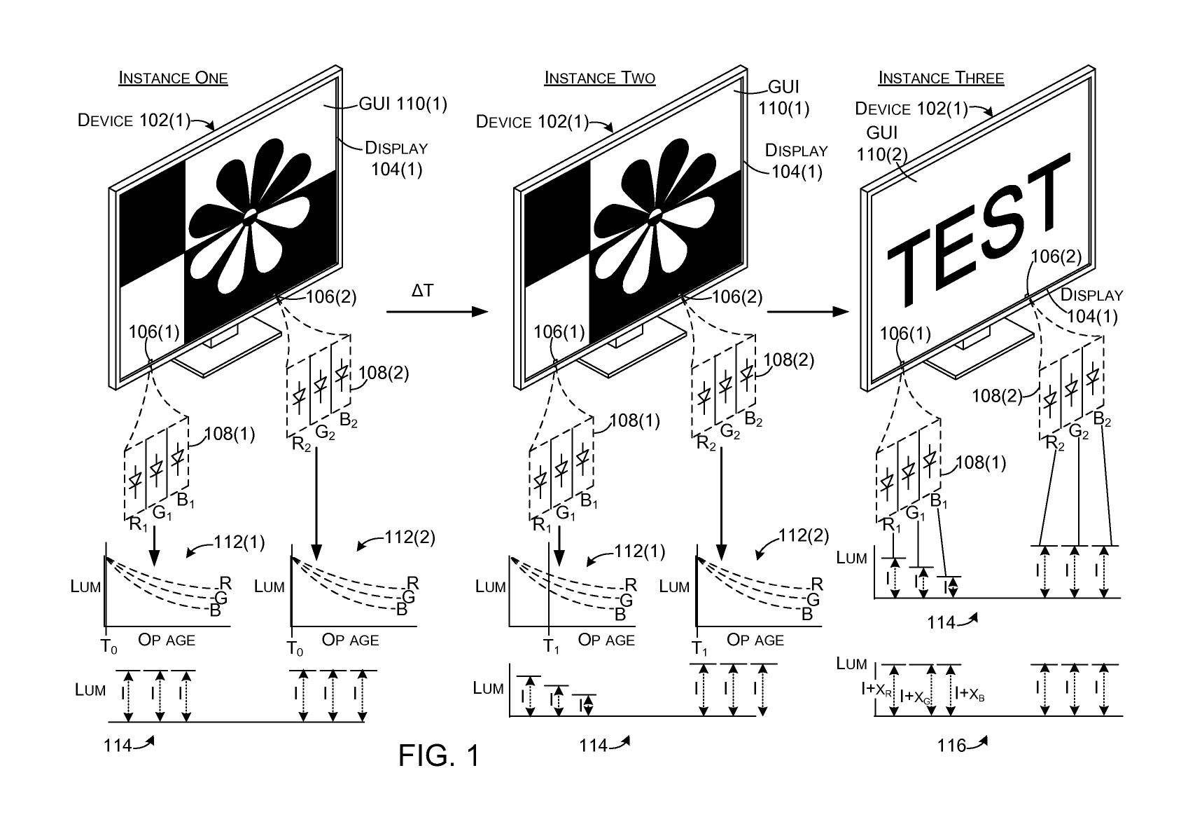

FIG. 1 shows a device 102(1) and illustrates an introductory display diode operational age example relative to device 102(1). The device can include a display or screen 104(1). The display can include multiple pixels 106. For sake of brevity only two pixels 106(1) and 106(2) are designated with specificity. Individual pixels can include one or more independently controllable light emitting diodes (LEDs) 108, such as organic light emitting diodes, inorganic light emitting diodes, and/or other controllable devices or material, such as quantum dot materials. Individual pixels may also be implemented using an LCD, a color filter, and a backlight (in which the backlight itself may be comprised of one or more LEDs). In an LCD, it is possible that the LEDs in the backlight or the LCD pixels themselves may degrade or otherwise suffer from defects or distortion. In the example of FIG. 1, each pixel 106 includes a red (R) LED, a green (G) LED, and a blue (B) LED. For purposes of explanation, FIG. 1 shows device 102(1) at Instance One, Instance Two, and Instance Three.

Starting at Instance One, assume for purposes of explanation that the device 102(1) is essentially new (e.g., operational time T₀). At this point, a GUI 110(1) is presented on the display 104(1). Also shown at Instance One is a performance degradation graph 112 for each pixel. The performance degradation graph charts diode luminosity over operational age for each color LED (e.g., R, G, and B) of the pixels of the display 104(1). Note that performance (e.g., luminosity) decreases with operational age. Note also that degradation graphs 112(1) and 112(2) are equal (and can be equal for all of the pixels of the device). Separate degradation graphs are shown for each pixel to show that individual pixels can experience different operational environments during the lifetime of the display 104(1). At this point, all of the LEDs of pixel 106(1) are performing ‘as new’ at time T₀ (since they are in fact new) on degradation graph 112(1). Similarly, all of the LEDs of pixel 106(2) are performing as new at time T₀ on degradation graph 112(2). Thus, as shown by luminosity graph 114, when driven at an equivalent intensity ‘I’, R₁, G₁, B₁, R₂, G₂, and B₂ would deliver the expected (and equal) luminosity (LUM). However, note that on GUI 110(1) of Instance One that pixel 106(1) is in a white-colored region of the GUI and pixel 106(2) is in a black-colored region. White color is generated at Instance One by driving R₁, G₁, and B₁ at equal intensities, such as 80% for example. In contrast, the black color is generated at Instance One by leaving R₂, G₂, and B₂ turned off (e.g., driving them at zero intensity). Now assume that the state of Instance One is continued for a duration of time (ΔT), such as 100 hours, until Instance Two.

At Instance Two, the GUI 110(1) has been displayed for 100 hours. At this point, as can be evidenced by comparing degradation graph 112(1) and 112(2), the operational age or effective age (represented by T₁) of the LEDs of pixel 106(1) are now different than the operational age (T₁) of the LEDs of pixel 106(2). For example, compare T₁ of degradation graph 112(1) to T₁ of degradation graph 112(2). Essentially, the R, G, and B LEDs 108(2) of pixel 106(2) are ‘new’ since they have not been powered (e.g., driven). In contrast, the R, G, and B LEDs 108(1) of pixel 106(1) have aged (e.g., T₁ on degradation graph 112(1) has shifted to the right). At this point, from an operational perspective, the LEDs 108(1) of pixel 106(1) are older than the LEDs 108(2) of pixel 106(2) and as such do not perform the same as the LEDs of pixel 106(2) or as they (e.g., LEDs 108(1)) did when they were ‘new’. Further, because the degradation curves of red LEDs, green LEDs, and blue LEDs are different, the operational age of the red, green, and blue LEDs of pixel 106(1) are different from one another. This can be evidenced from the luminosity graph 114 of Instance Two. Recall that each LED is driven at the same intensity I. However, the resultant luminosities (vertical axis) of the LEDs of pixel 106(1) are less than those of the LEDs of pixel 106(2). Further, the blue LED pixel 106(1) has the lowest luminosity, the green LED has the intermediate luminosity and the red LED the highest luminosity (though still lower than all of the LEDs of pixel 106(2)). Assume that at this point GUI 110(1) is changed to GUI 110(2) of Instance Three.

Instance Three shows GUI 110(2) presented on display 104(1). On GUI 110(2) both pixel 106(1) and pixel 106(2) are white. Assume further that both pixels are intended to be the same ‘color’ white (e.g., identical colors) and the same intensity as one another. Recall however from the discussion of Instance Two that the LEDs 108 of these two pixels are no longer the same operational or effective age. The luminosity graph 114 from Instance Two is reproduced at Instance Three to illustrate this point. If driven at equivalent intensities, the luminosity of LEDs 108(1) vary among themselves and are lower than the luminosity of LEDs 108(2). This would produce two visual problems. First, pixel 106(1) would appear dimmer (e.g. less luminous) than pixel 106(2) on the GUI 110(2).

Second, recall that the specific color of white desired is accomplished by an individual pixel by equal luminosity from its red, green, and blue LEDS. However, in this case, the blue LED 108(1) is less luminous than the green LED 108(1), which is less luminance than the red LED 108(1). As such, the ‘color’ produced by pixel 106(1) will be different than the ‘color’ produced by pixel 106(2). For instance, pixel 106(1) might appear as ‘off white’ while pixel 106(2) appears as a ‘true white’. To address these issues, device 102(1) can adjust the intensity I that it drives the LEDs 108(1) of pixel 106(1) to create more uniformity of luminance and color between pixel 106(1) and 106(2). For example, assume that intensity I is 80%. The LEDs 108(2) of pixel 106(2) can be driven at 80% intensity. The LEDs 108(1) of pixel 106(1) can be driven at an intensity that is greater than I, such as I+X to get back to the luminance produced by LEDs 106(2) at 80% at Instance 1. Further, the ‘X’ value can be customized for each LED 106(1) to reflect its degradation curve. For example, the X value for the blue LED (e.g., (X_{B})) can be the largest since it has suffered the most performance degradation. The X value for the green pixel 106(1) (e.g., (X_{G})) can be slightly less and the X value for the red pixel (e.g., (X_{R})) can be even less. For instance, X_{B} could equal 14%, X_{G} could equal 12%, and X_{R} could equal 10%. As such, by driving LEDs 108(2) at 80% and red LED 108(1) at 90%, green LED 108(1) at 92%, and blue LED 108(1) at 94%, the display can simulate the ‘new’ condition where all of the LEDs 108(1) and 108(2) would be driven at 80% to achieve the same color and luminosity. Note that this is a somewhat simplified example in that by using ‘white’ and ‘black’ the operational age of the LEDs of an individual pixel remain relatively close. However, if the GUI 110(1) in Instance One was blue and black for example, rather than white and black, and GUI 110(2) of Instance Three was white, then the blue LED 106(1) of pixel 108(1) would be aging at Instances One and Two, while the red and green LEDs 106(1) of pixel 108(1) were not. Such a scenario can be addressed in a similar manner to compensate for intra pixel LED degradation and interpixel LED degradation.

In still another example, the intensity of the aging LEDs may not be able to be increased to correct to original luminosity. For instance, in the above described example, the frame rendering drove the LEDs at 80% at Instance Three so the intensity could be increased, such as to 90%, 92% and 94%. However, if GUI 110(2) is driving the pixels at 100% intensity then the values cannot be adjusted higher. In such a case, various techniques can be applied. In one case, all of the intensities could be lowered, such as to 75%, then the LEDs of pixel 106(1) (e.g., the aging pixels) can be adjusted upward. Such a configuration can maintain a relative appearance of the pixels (e.g., pixel 106(1) looks the same as pixel 106(2) but at a lower (e.g., dimmed) intensity than specified in the frame rendering for GUI 110(2). These concepts are described in more detail below.

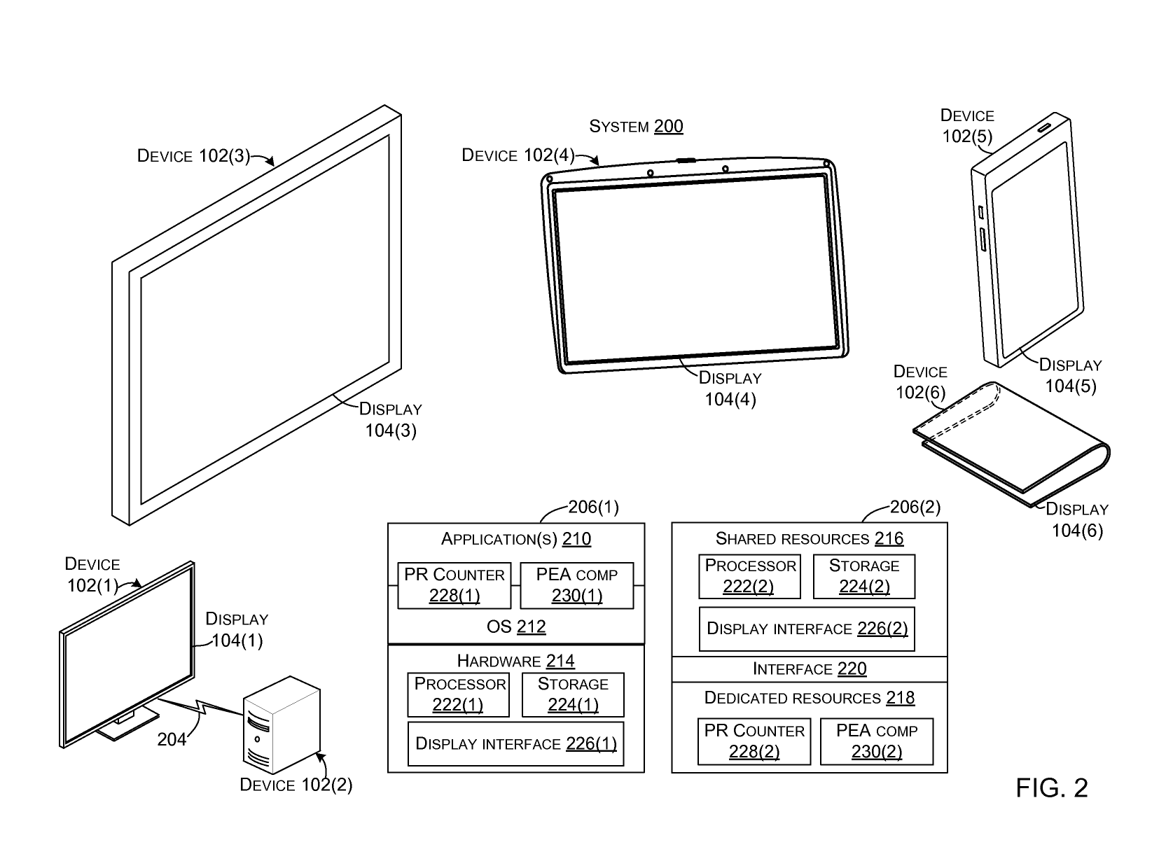

FIG. 2 illustrates an example system 200 that shows various device implementations. In this case, five device implementations are illustrated. Device 102(1) can operate cooperatively with device 102(2) that is manifest as a personal computer or entertainment console. Device 102(3) is manifest as a television, device 102(4) is manifest as a tablet, device 102(5) is manifest as a smart phone, and device 102(6) is manifest as a flexible or foldable device, such as an e-reader, tablet, or phone that can be flexed into different physical configurations, such as opened or closed. Flexing the device can impart stress forces on individual pixels.

Individual devices can include a display 104. Devices 102 can communicate over one or more networks, such as network 204. While specific device examples are illustrated for purposes of explanation, devices can be manifest in any of a myriad of ever-evolving or yet to be developed types of devices.

Individual devices 102 can be manifest as one of two illustrated configurations 206(1) and 206(2), among others. Briefly, configuration 206(1) represents an operating system centric configuration and configuration 206(2) represents a system on a chip configuration. Configuration 206(1) is organized into one or more applications 210, operating system 212, and hardware 214. Configuration 206(2) is organized into shared resources 216, dedicated resources 218, and an interface 220 there between.

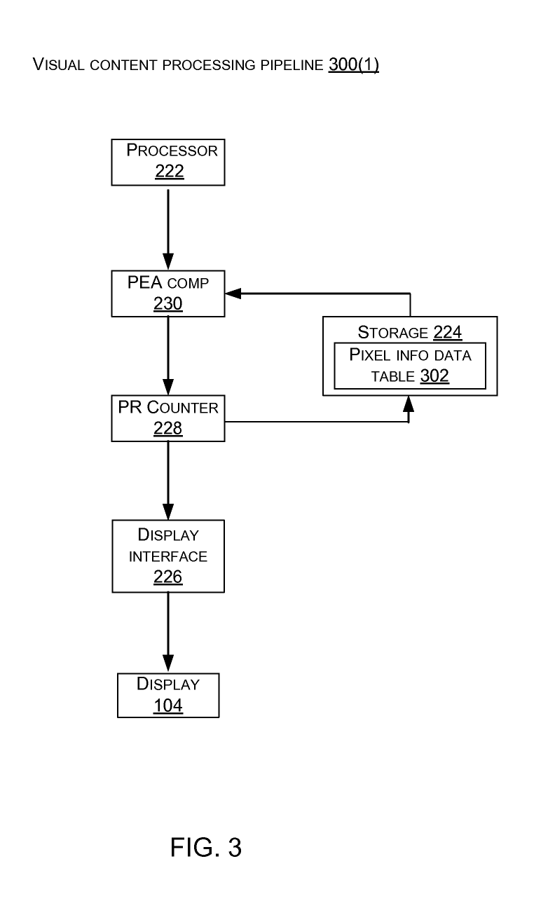

In either configuration, the devices 102 can include a processor 222, storage 224, a display interface 226, a pixel runtime (PR) counter 228, and/or a pixel effective age (PEA) compensation component 230. The function of these elements is described in more detail below relative to FIG. 3. Individual devices can alternatively or additionally include other elements, such as input/output devices, buses, etc., which are not illustrated or discussed here for sake of brevity.

Devices 102(1) and 102(2) can be thought of as operating cooperatively to perform the present concepts. For instance, device 102(2) may include an instance of processor 222, storage 224, display interface 226, pixel runtime counter 228, pixel effective age (PEA) compensation component 230. The device 102(2) can receive content data and process the content data into frame renderings that compensate for effective aging of individual diodes on the display of device 104(1). Device 102(2) can send adjusted frame renderings to device 102(1) for presentation on display 104(1). In contrast, devices 102(3)-102(5) may be self-contained devices that include both an instance of the display 104 and an instance of processor 222, storage 224, display interface 226, pixel runtime counter 228, and pixel effective age (PEA) compensation component 230. Thus, in this implementation, device 102(2) can implement the present concepts and send the adjusted frames to device 102(1) for presentation. As such, device 102(1) can be a legacy (e.g., pre-existing device) that when coupled to device 102(2) can offer enhanced performance (e.g. closer to original) as device 102(1) ages from use.

In an alternative implementation, a device such as device 102(3) could include a SOC configuration, such as an application specific integrated circuit (ASIC) that includes the pixel runtime counter 228, and pixel effective age compensation component 230. Such a device can maintain a high level of performance even as it ages from use. Other device implementations, such as tablet device 102(4) can include a processor, such as CPU and/or GPU that renders frames and can also execute the pixel runtime counter 228, and pixel effective age compensation component 230, on the same processor or on another processor.

From one perspective, any of devices 102 can be thought of as computers. The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage, such as storage that can be internal or external to the computer. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and/or flash memory, among others.

In one operating system centric configuration 206(1), the pixel run-time counter 228(1) can be embedded in an application 210 and/or the operating system 212 to record sub-pixel level run-time. The pixel effective age compensation component 230 can be similarly situated to receive information from the pixel run time counter, and utilize the information to adjust frame renderings for delivery to the display interface 226(1).

As mentioned above, configuration 206(2) can be thought of as a system on a chip (SOC) type design. In such a case, functionality provided by the device can be integrated on a single SOC or multiple coupled SOCs. One or more processors can be configured to coordinate with shared resources 216, such as memory, storage, etc., and/or one or more dedicated resources 218, such as hardware blocks configured to perform certain specific functionality. Thus, the term “processor” as used herein can also refer to central processing units (CPUs), graphical processing units (CPUs), controllers, microcontrollers, processor cores, or other types of processing devices. The pixel run-time counter 228 and pixel effective age compensation component 230 can be manifest as dedicated resources 218 and/or as shared resources 216.

One example SOC implementation can be manifest as an application specific integrated circuit (ASIC). The ASIC can include the pixel run-time counter 228 and/or pixel effective age compensation component 230. For example, the ASIC can include logic gates and memory or may be a microprocessor executing instructions to accomplish the functionality associated with the pixel run-time counter 228 and/or pixel effective age compensation component 230, such as the functionality described below relative to FIGS. 3 and/or 4. For instance, the ASIC can be configured to convert image data into frame renderings for multiple pixels. The ASIC can alternatively or additionally be configured to receive a frame rendering and to generate an adjusted frame rendering that compensates for luminance degradation of individual pixels based at least upon the stored pixel information. In one implementation, the ASIC may be manifest in a monitor type device, such as device 102(3) that does not include another processor. In another implementation, the ASIC may be associated with a display in a device that also includes a CPU and/or GPU. For instance, in a device such as tablet device 102(4), the ASIC may be associated with display 104(4) and may receive frame renderings from the device's CPU/GPU and then adjust the frame renderings to compensate for luminance degradation.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU or CPUs). The program code can be stored in one or more computer-readable memory devices, such as computer-readable storage media. The features and techniques of the component are platform-independent, meaning that they may be implemented on a variety of commercial computing platforms having a variety of processing configurations.

FIG. 3 shows an example visual content (e.g., image) processing pipeline 300(1) employing elements introduced relative to FIG. 2. In the visual content pipeline, processor 222 can operate on visual content, such as static and/or video content. The processor can render a frame to ultimately be presented on the display 104 as a GUI. The pixel effective age compensation component 230 can receive the frame rendering from the processor. Assume for purposes of explanation that the display 104 is new and this is the first frame rendering. As such, the pixel effective age compensation component 230 does not perform any adjustment to the frame rendering. The visual content processing pipeline 300(1) can be customized to an individual display model, since the properties of the hardware (e.g., the LEDs) may differ between models and/or manufactures.

The pixel run-time counter 228 can receive the frame rendering from the pixel effective age compensation component 230 and determine whether to store information about the pixels on storage 224. In some cases, the pixel run-time counter 228 can store pixel information about each frame rendering. Other implementations may regard such resource usage as prohibitive. These implementations may store information about individual frames selected based upon defined intervals, such as one frame every second or every three seconds, for example. Alternatively, the interval could be based upon a number of frames. For instance, the interval could be 50 frames or 100 frames, for instance. For purposes of explanation, assume that the pixel run-time counter 228 saves pixel information about the pixels of this frame. The pixel information can relate to individual LEDs relative to individual frames. For instance, the information can relate to the intensity that each LED was driven at in the frame rendering. The pixel information can be stored in a pixel information data table 302 in the storage 224. The pixel run-time counter 228 can supply the frame rendering to the display interface 226 to drive the display pixels to present the frame on the display 104.

Now assume that the pixel effective age compensation component 230 receives another frame rendering from the processor 222. The pixel effective age compensation component can access the pixel information in the pixel information data table 302 and simulate or predict the operational age of individual pixels (e.g., their LEDs). The pixel effective age compensation component can use this operational age prediction to adjust the second frame rendering so that when presented on the display, the second frame more closely matches the appearance of the second frame if it were presented on the display in brand new condition. The pixel effective age compensation component can then replace the second frame with the adjusted frame.

Recall that in some instances, the adjustment can entail increasing the intensity of individual LEDs to restore their luminosity output to original levels (e.g., brand new condition). However, as mentioned above, in some instances this remedy is not available. For instance, if the LEDs are already being driven at their maximum intensity (e.g., 100%) then they cannot be driven at a higher intensity and other solutions can be utilized. Some of these solutions can involve ‘dimming.’ Dimming can be thought of as lowering the intensity that relatively highly performing (e.g., relatively young operational age) LEDs are driven at so that their output can be matched by the lower performing LEDs. Variations on dimming are described below.

Note that in this implementation, once the frame adjustment process is underway and frames are being adjusted by the pixel effective age compensation component 230, each successive frame is adjusted based upon the stored pixel information, and some subset of these adjusted frames are stored by the pixel run-time counter 228.

The pixel run-time counter 228 can receive the adjusted second frame rendering and determine whether to store the pixel information according to the defined interval. Note that in this configuration, the pixel run-time counter 228 can store the pixel information of the adjusted second frame rendering rather than the original second frame rendering. Thus, the stored pixel information can convey the actual intensity that the LEDs are driven at rather than the values defined in the original second frame rendering. As such, the stored pixel information can provide a more accurate representation of the operational life or age of the LEDs. The pixel run-time counter can supply the adjusted second frame rendering to the display interface 226 to create the corresponding GUI on the display.

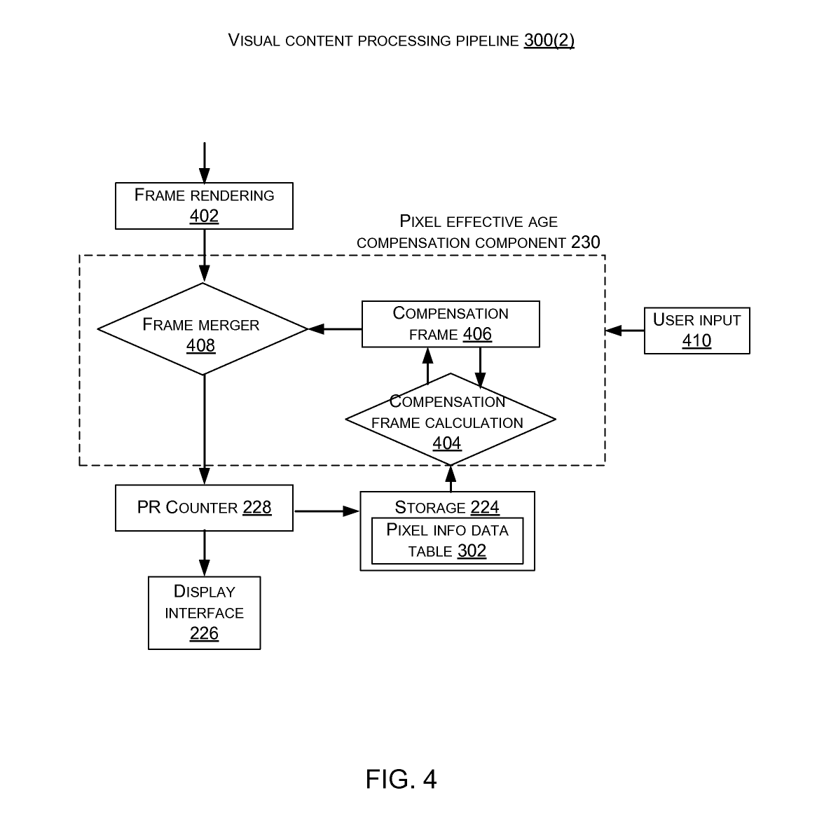

FIG. 4 shows an alternative visual content processing pipeline 300(2). In the illustrated configuration, a frame rendering 402 can be received by the pixel run-time counter 228, which can store pixel information about the frame in the pixel information data table 302. The pixel effective age compensation component 230 can use the pixel information to perform a compensation frame calculation 404 to generate a compensation frame 406. The pixel effective age compensation component can then merge the compensation frame 406 with the frame rendering 402 (e.g., frame merger 408).

In some implementations, the pixel effective age compensation component 230 may receive user input 410 relating to display preferences. For instance, the user may weight image brightness higher than color accuracy, or vice versa. Further, the user may have different preferences in different scenarios. For instance, in a bright sunlit outside scenario, the user may weight display brightness as the most important so the user can see the image despite the bright sunlight. In another scenario, such as in a home or office scenario, the user may value color quality higher than overall brightness. The pixel effective age compensation component 230 can utilize this user input 410 when calculating intensity values for the compensation frame 406. In one such case, the pixel effective age compensation component can utilize the user input as a factor for selecting which compensation algorithm to employ. Several compensation algorithm examples are described below and briefly, some are more effective at addressing overall brightness and some are more effective at addressing color accuracy. Further, in some implementations, the user input 410 may include user feedback. For instance, the pixel effective age compensation component 230 may select an individual compensation (with or without initial user input). The user can then look at the resultant images and provide feedback regarding whether the user likes or dislikes the image, whether the colors look accurate, etc. The pixel effective age compensation component can then readjust the compensation frame calculation to attempt to address the user feedback.

Additional details of one example of the operation flow of the pixel run-time counter 228 are described below. In this implementation, the pixel run-time counter 228 can receive an individual frame and associated pixel information, such as LED intensity values and display dimming level settings. The pixel run-time counter 228 can record the full frame RGB values and dimming level at the defined sampling rate. Once the frame's pixel information is recorded, the pixel run-time counter can calculate the run-time increment for individual sub-pixels based on the recorded data. The values of the run-time increment will be used to update the memory, where the accumulated run-time data is stored.

The pixel run-time counter 228 can function to convert the time increment of each frame's RGB grey levels into effective time increments at certain grey levels, like 255 in a scenario using 8 bit sampling from 0-255. This allows the run-time data to be stored on significantly smaller memory. In general, one such algorithm can be expressed in a function shown below:

Δ_{i,j}²⁵⁵= [symbol] (G_{i,j},φ,β,T,Δt)

Here, i and j represent the coordinates of the sub-pixel. Δt²⁵⁵ is the effective time increment at a grey level of 255, whereas Δt is the actual time increment at a grey level of G_{i,j}. T is the operational temperature of the display, β is the luminance acceleration factor, and φ is the dimming level. The function can convert the time increment at any grey level of G_{i,j} in the range of [0, 254] to the effective time increment at 255. The explicit formula of the function strongly depends on the LED lifetime characteristic employed in the display and may be adapted to different forms.

Due to the different aging characteristics of the R, G, and B LED sub-pixels, the luminance acceleration factor β can be different for R, G, B such that three individual functions can be applied to each color.

Δt_{i,j}^{R255}= [symbol] _{R}(G_{i,j}^{R},φ,β_{R},T,Δt)

Δt_{i,j}^{G255}= [symbol] _{G}(G_{i,j}^{G},φ,β_{G},T,Δt)

Δt_{i,j}^{B255}= [symbol] _{B}(G_{i,j}^{B},φ,β_{B},T,Δt)

### Accumulated Run Time Generation Example

With a sampling rate of 1 sample/sec, the run-time counter can record one sub-pixel grey level of 50 with actual time incremental of Δt₅₀=1 sec. A function shown below will convert that to the effective time increment of Δt₂₅₅=0.045 sec. Luminance acceleration factor of 1.9 is used here. Other functions may be used in other scenarios.

$$Δ {t}_{255} = {( \frac{50}{255} )}^{1.9} Δ {t}_{50}$$

The accumulated run-time data recorded by the pixel run-time counter 228 can be used to calculate the compensation frame which will be used to compensate the image sticking and/or LED aging on the LED display. During the compensation process, the algorithm can merge the frame output from the processor with the compensation frame to greatly reduce the visibility of image sticking on the display.

Note that implementations that calculate operational age of individual run times are described in great detail above. Note that an alternative implementation can measure degradation of a device directly, and then use that measurement to inform the content compensation. For example, LCD displays can be run through a temperature cycle to release mechanical stresses that may be built up due to various bonding and assembling steps during manufacture. Once these mechanical stresses are released, the LCD display may show some distortion due to this release. Some implementations can utilize a sensor, e.g., a camera, to measure the distortion and save the measurements in the device. These measurements would be static (as opposed to the continuous on-time measurements for the OLED case), and the measurements would be used just the same as the above-example to adjust the image content to compensate for the LCD display degradation.

Returning to the flow chart of FIG. 4, the pixel effective age compensation component 230 can fetch the stored pixel information from the pixel information data table 302. The pixel effective age compensation component can calculate the compensation frame based on the predictable degradation characteristics of the LED. Once the compensation frame is obtained, a compensation frame buffer can be updated. In the visual content processing pipeline 300, the rendering frame 402 from the processor can be fed to the pixel effective age compensation component 230 for the frame merger, in which the input frame (e.g., frame rendering 402) is merged with the compensation frame 406 stored in the buffer. The algorithms used in the frame merger can vary depending upon a specified or desired level of intended compensation.

Three examples utilizing different algorithms to produce compensation are described below.

The first example can produce partial compensation with maximum brightness. In this compensation method, the algorithm intends to maximally retain the brightness of the image by accepting a limited amount of image sticking presence on the display. Assuming a frame rendering 402 with four pixels at values of X1=0.9, X2=0.8, X3=0.5 and X4=0.6, as well as a compensation frame 406 with corresponding pixel values of C1=0.8, C2=0.9, C3=0.7 and C4=0.7, the output pixel values can be calculated as:

Y1=X1/C1=1.125→1

Y2=X2/C2=0.889

Y3=X3/C3=0.714

Y4=X4/C4=0.857

Here, X1/C1 results in a value larger than one. Since the display interface only accepts values in the range of [0,1], Y1 can be truncated to 1. The final input frame will be Y1=1, Y2=0.889, Y3=0.714, and Y4=0.857. It can be seen that while pixels Y2, Y3, Y4 can be completely compensated for the image sticking, pixel Y1 is under-compensated due to the limit of display driving capability. As a result, image sticking may still be visible in Y1, but in a diminished amount. Also, this algorithm can maximally keep the image brightness to the original state shown on the pristine LED display, i.e., before any aging of the LED materials.

The second example can provide complete compensation with brightness loss. In this compensation method, the algorithm intends to provide complete compensation of the image sticking by scarifying the display brightness. Assuming a frame rendering 402 with four pixels at values of X1=0.9, X2=0.8, X3=0.5 and X4=0.6, as well as compensation frame 406 with corresponding pixel values of C1=0.8, C2=0.9, C3=0.7 and C4=0.7, the output pixel values can be calculated as

T1=X1/C1=1.125

T2=X2/C2=0.889

T3=X3/C3=0.714

T4=X4/C4=0.857

Y1=T1/Max(T1,T2,T3,T4)=1.125/1.125=1

Y2=T2/Max(T1,T2,T3,T4)=0.889/1.125=0.790

Y3=T3/Max(T1,T2,T3,T4)=0.714/1.125=0.635

Y4=T4/Max(T1,T2,T3,T4)=0.857/1.125=0.762

Here, all the values fall in the range of [0,1] without clipping. Moreover, this can allow complete compensation of the image sticking on the display by maintaining the correct relative ratio in output values. However, the overall image brightness will be decreased due to normalization to the maximum values.

The third example can produce partial compensation with maximum brightness. In this compensation method, the algorithm can do an improved and potentially optimal compensation by balancing the image brightness and image sticking compensation, which falls in between the two extreme cases discussed above in the first and second examples. The algorithm can perform content analysis in the image to choose the optimal compensation level.

Assuming a frame rendering 402 with four pixels at values of X1=0.9, X2=0.8, X3=0.5, and X4=0.6, as well as a compensation frame 406 with corresponding pixel values of C1=0.8, C2=0.9, C3=0.7, and C4=0.7, the output pixel values can be calculated as:

Y1=(X1/C1)*α=1.125*α

Y2=(X2/C2)*α=0.889*α

Y3=(X3/C3)*α=0.714*α

Y4=(X4/C4)*α=0.857*α

Here, the scale factor α will be introduced to adjust the fully compensated output values. The scale factor α can be in the range of [0,1] based on the image content. For instance, if a histogram of the current image (frame) indicates a majority of the content falls in the low grey shade region, a scale factor of α=1 can be used to ensure correct compensation and brightness level. In another scenario, if the content falls in the high grey shade region mostly, a smaller value can be used depending on the histogram analysis.

To summarize, current LED displays suffer from image degradation due to operational aging of the light emitting materials, i.e., irreversible decrease of luminance with operation time. Moreover, the red, green, and blue emitting materials have different aging speeds. These occurrences can lead to image degradation from at least uneven brightness between pixels and/or non-uniform colors between pixels. The present implementations can monitor the display's LEDs, such as by using a built-in sub-pixel run-time counter in the image processing pipeline. Some implementations can then make adjustments to the images based upon the condition of the LEDs to compensate for degradation. Further, the compensation can be achieved without changing the display hardware. The compensation can accommodate any LED aging characteristics with a predictable luminance drop as a function of operation time.

Note that the above discussion can address each pixel individually (e.g., can determine what relative intensity to drive each individual LED of each individual pixel). Further, the present implementations can additionally increase the overall (e.g., global) power that is used to drive the display to increase the overall brightness. Thus, this overall increased driving power can compensate for the ‘dimming’ described above to restore the additional display intensity to closer to original (e.g., as new) levels.

### Method Examples

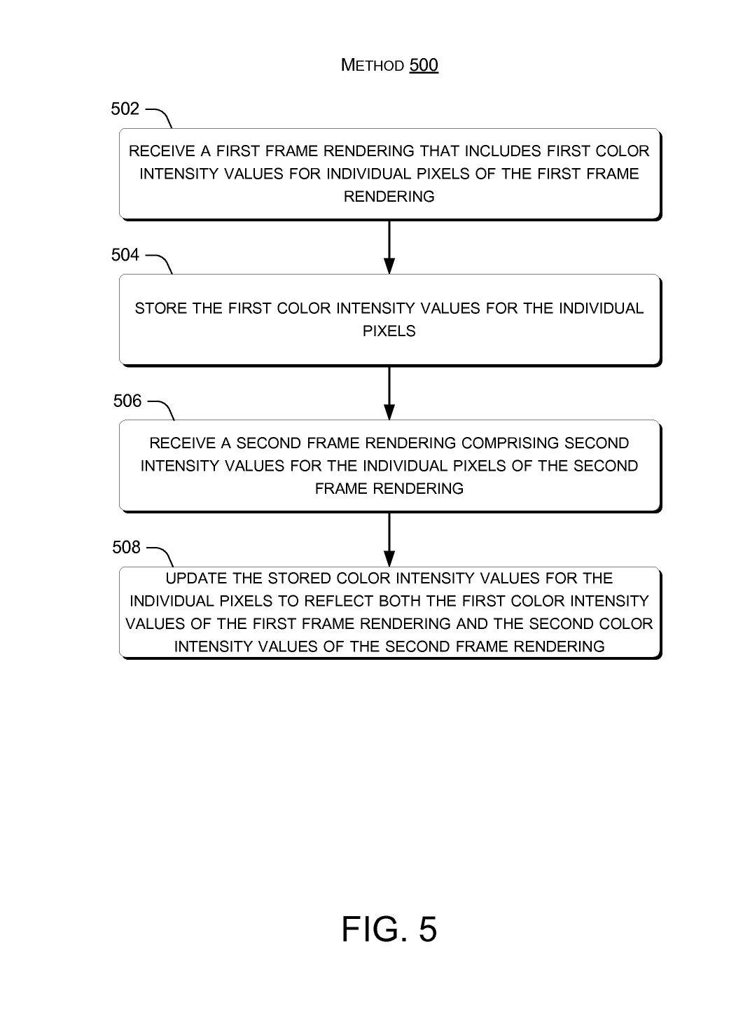

FIG. 5 shows an example method 500. In this case, block 502 can receive a first frame rendering that includes first color intensity values for individual pixels of the first frame rendering.

Block 504 can store the first color intensity values for the individual pixels. In one example, the stored color intensity values include a red color intensity value, a green color intensity value, and a blue color intensity value for the individual pixels.

Block 506 can receive a second frame rendering comprising second intensity values for the individual pixels of the second frame rendering. In one case, the first frame rendering and the second frame rendering are consecutive sequential frame renderings (e.g., pixel information about every frame can be stored). In another implementation, the first frame rendering and the second frame rendering are separated by intervening frame renderings that are not reflected in the stored color intensity values (e.g., pixel information is stored for a subset of frames to reduce resource usage). Some of these latter implementations can identify a predefined frame capture interval and select the second frame rendering that satisfies the frame capture interval relative to the first frame rendering. For example, the frame capture interval can be based upon a time duration or a number of intervening frames between the first frame rendering and the second frame rendering.

Block 508 can update the stored color intensity values for the individual pixels to reflect both the first color intensity values of the first frame rendering and the second color intensity values of the second frame rendering. The updating can also entail storing values for other parameters that can contribute to the relative age of the pixels. For instance, in addition to color intensity, the parameters can include environmental parameters, such as operating temperature, humidity, and/or mechanical stress, among others.

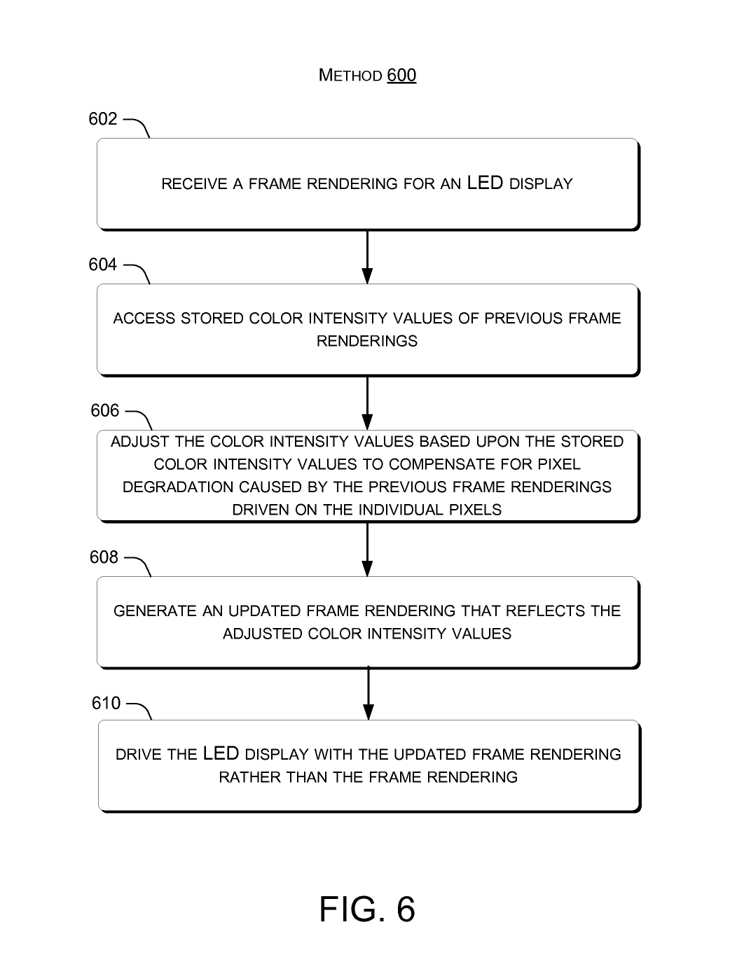

FIG. 6 shows an example method 600. In this case, block 602 can receive a frame rendering for an LED display. In one case, the frame rendering can include color intensity values for individual pixels of the first frame rendering.

Block 604 can access stored color intensity values of previous frame renderings. The stored color intensity values can be one parameter of various parameters that can be stored that can provide pixel information. In addition to time and intensity the other parameters can relate to temperature, humidity, and/or mechanical stress, among others.

Block 606 can adjust the color intensity values based upon the stored color intensity values to compensate for pixel degradation caused by the previous frame renderings driven on the individual pixels. In some cases, the adjusting can entail adjusting the red color value based upon a red LED aging (e.g. degradation) rate, adjusting the green color value based upon a green LED aging rate, and adjusting the blue color value based upon a blue LED aging rate.

Block 608 can generate an updated frame rendering that reflects the adjusted color intensity values.

Block 610 can drive the LED display with the updated frame rendering rather than the frame rendering.

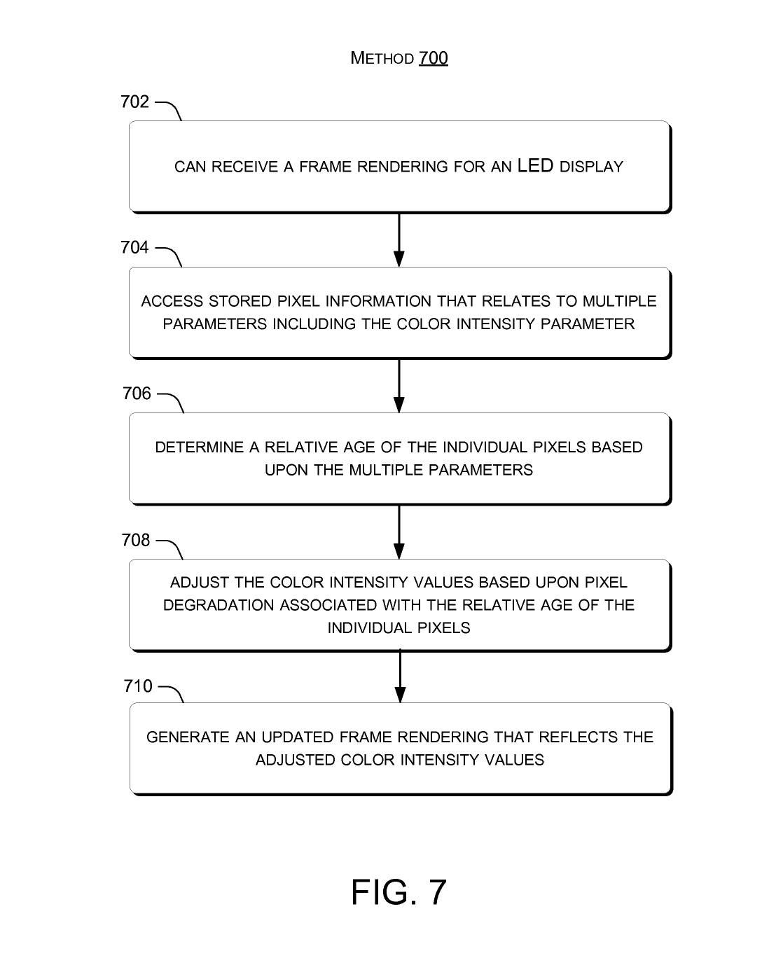

FIG. 7 shows an example method 700. In this case, block 702 can receive a frame rendering for an LED display. The frame rendering can include values of a color intensity parameter for individual pixels of the frame rendering.

Block 704 can access stored pixel information that relates to multiple parameters including the color intensity parameter.

Block 706 can determine a relative (e.g., a relative operational) age of the individual pixels based upon the multiple parameters. In some configurations, the determination can involve determining the relative age of individual LEDs within the individual pixels. In some cases, the relative age can be determined utilizing the color intensity parameter and at least one other parameter of the multiple parameters, including time of illumination, operating temperature, and/or mechanical stress, among others.

Block 708 can adjust the color intensity values based upon pixel degradation associated with the relative age of the individual pixels. In some cases, the adjusting can also be based upon user input.

Block 710 can generate an updated frame rendering that reflects the adjusted color intensity values.

The described methods can be performed by the systems and/or devices described above relative to FIGS. 1-4, and/or by other devices and/or systems. The order in which the methods are described is not intended to be construed as a limitation, and any number of the described acts can be combined in any order to implement the method, or an alternate method. Furthermore, the method can be implemented in any suitable hardware, software, firmware, or combination thereof, such that a device can implement the method. In one case, the method is stored on computer-readable storage media as a set of instructions such that execution by a computing device causes the computing device to perform the method.

### Additional Examples

Various examples are described above. Additional examples are described below. One example is manifest as a display, a processor, storage, a pixel run time counter, and a frame compensation component. The display can include multiple pixels and individual pixels can comprise multiple color light emitting diodes (LEDs). The processor can be configured to convert image related data into frame renderings for driving the multiple pixels of the display. The storage can be accessible by the processor. The pixel run time counter is configured to store pixel information on the storage that reflects time and intensity parameters at which the frame renderings have driven the multiple color LEDs of the individual pixels in the frame renderings. The frame compensation component is configured to receive a new frame rendering and to generate an adjusted frame rendering that compensates for luminance degradation of individual pixels based at least upon the stored pixel information.

Another example can be manifest as a combination of any of the above and/or below examples where the stored pixel information includes additional parameters.

Another example can be manifest as a combination of any of the above and/or below examples where the additional parameters include an operating temperature parameter and/or a mechanical stress parameter.

Another example can be manifest as a combination of any of the above and/or below examples where the multiple color LEDs comprise at least a first color diode, a second color diode, and a third color diode per pixel.

Another example can be manifest as a combination of any of the above and/or below examples where the first color diode comprises a red diode, the second color diode comprises a green diode, and the third color diode comprises a blue diode and wherein the stored pixel information reflects time parameter values and intensity parameter values for the red diode, the green diode and the blue diode of the individual pixels.

Another example can be manifest as a combination of any of the above and/or below examples further comprising luminance degradation profiles for the red diodes, the green diodes, and the blue diodes stored on the storage.

Another example can be manifest as a combination of any of the above and/or below examples where the pixel effective age compensation component is configured to predict the luminance degradation for each color LED of each pixel from the stored information.

Another example can be manifest as a combination of any of the above and/or below examples where the pixel effective age compensation component is configured to calculate the adjusted frame rendering from the predicted luminance degradation of an individual color LED of an individual pixel and the respective luminance degradation profile for the color of the individual color LED.

Another example can be manifest as a combination of any of the above and/or below examples further comprising a display interface and wherein the pixel effective age compensation component is configured to send the adjusted frame rendering to the display interface rather than the new frame rendering.

Another example can be manifest as a combination of any of the above and/or below examples manifest as a single device or wherein the display is mounted in a housing of a first device and the processor, storage, pixel run time counter, and pixel effective age compensation components are embodied on a second device that is communicatively coupled to the first device.

A further example can receive a first frame rendering comprising first color intensity values for individual pixels of the first frame rendering and store the first color intensity values for the individual pixels. The example can also receive a second frame rendering comprising second color intensity values for the individual pixels of the second frame rendering and update the stored color intensity values for the individual pixels to reflect both the first color intensity values of the first frame rendering and the second color intensity values of the second frame rendering.

Another example can be manifest as a combination of any of the above and/or below examples where the stored color intensity values comprise a red color intensity value, a green color intensity value, and a blue color intensity value for the individual pixels.

Another example can be manifest as a combination of any of the above and/or below examples where the first frame rendering and the second frame rendering are consecutive sequential frame renderings or wherein the first frame rendering and the second frame rendering are separated by intervening frame renderings that are not reflected in the stored color intensity values.

Another example can be manifest as a combination of any of the above and/or below examples further comprising identifying a predefined frame capture interval and selecting the second frame rendering that satisfies the frame capture rate relative to the first frame rendering.

Another example can be manifest as a combination of any of the above and/or below examples where the frame capture rate is based upon a time duration or a number of intervening frames between the first frame rendering and the second frame rendering.

Another example can be manifest as a combination of any of the above and/or below examples where the first color intensity values and the second color intensity values relate to an intensity parameter and wherein the storing and updating store pixel information relating to additional parameters.

Another example can be manifest as a combination of any of the above and/or below examples where the additional parameters relate to operating temperature experienced by the individual pixels and mechanical stresses experienced by the individual pixels.

A further example can receive a frame rendering for an LED display, the frame rendering comprising color intensity values for individual pixels of the first frame rendering and access stored color intensity values of previous frame renderings; the stored color intensity values reflecting time and intensity parameters at which the individual pixels have been driven in the previous frame renderings. The example can adjust the color intensity values based upon the stored color intensity values to compensate for pixel degradation caused by the previous frame renderings driven on the individual pixels and generate an updated frame rendering that reflects the adjusted color intensity values.

Another example can be manifest as a combination of any of the above and/or below examples where individual pixels comprise at least a first color diode, a second color diode, and a third color diode per pixel wherein the first color diode comprises a red diode, the second color diode comprises a green diode, and the third color diode comprises a blue diode and wherein the color intensity values comprise a red color value for the red pixel, a green color value for the green pixel, and a blue color value for the blue pixel, and wherein the adjusting comprises adjusting the red color value based upon a red LED aging rate, adjusting the green color value based upon a green LED aging rate, and adjusting the blue color value based upon a blue LED aging rate.

Another example can be manifest as a combination of any of the above and/or below examples further comprising driving the LED display with the updated frame rendering rather than the frame rendering.

Another example can receive a frame rendering for an LED display, the frame rendering comprising values of a color intensity parameter for individual pixels of the frame rendering and access stored pixel information that relates to multiple parameters including the color intensity parameter. The example can determine a relative age of the individual pixels based upon the multiple parameters and adjust the color intensity values based upon pixel degradation associated with the relative age of the individual pixels. The example can generate an updated frame rendering that reflects the adjusted color intensity values.

Another example can be manifest as a combination of any of the above and/or below examples where the determining comprises determining the relative age utilizing the color intensity parameter and at least one other parameter of the multiple parameters, including time of illumination, operating temperature, or mechanical stress.

Another example can be manifest as a combination of any of the above and/or below examples where the determining comprises determining the relative age of individual LEDs within the individual pixels.

Another example can be manifest as a combination of any of the above and/or below examples where the adjusting is also based upon user input.

A further example can include a processor configured to convert image data into frame renderings for multiple pixels, store pixel information on the storage that reflects time and intensity parameters that the frame renderings have driven an LED of at least one of the multiple pixels in the frame renderings, and generate an adjusted frame rendering that compensates for luminance degradation of the LED based at least upon the stored pixel information. The example can also include memory accessible by the processor.

Another example can be manifest as a combination of any of the above and/or below examples manifest on a single device.

Another example can be manifest as a combination of any of the above and/or below examples where the single device also includes a display upon which the processor presents the adjusted frame rendering.

Another example can include a display comprising multiple individually controllable pixels that comprise light emitting diodes (LEDs) and an application specific integrated circuit configured to receive frame renderings for presentation on the display and further configured to store pixel information that reflects time and intensity parameters at which the frame renderings have driven an individual LED of at least one of the multiple individually controllable pixels in the frame renderings and further configured to generate an adjusted frame rendering that compensates for luminance degradation of the individual LED based at least upon the stored pixel information.

Another example can be manifest as a combination of any of the above and/or below examples manifest as a freestanding monitor or wherein the display device is integrated into a device that includes a processor configured to generate the frame renderings.

### CONCLUSION

Although techniques, methods, devices, systems, etc., pertaining to display diode relative age correction are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A system, comprising:
a display comprising multiple pixels, and wherein individual pixels comprise multiple color light emitting diodes (LEDs);
a processor configured to convert image related data into frame renderings for driving the multiple pixels of the display;
storage accessible by the processor;
a pixel run time counter configured to store pixel information on the storage that reflects time and intensity parameters that the frame renderings have driven the multiple color LEDs of the individual pixels in the frame renderings; and,
a pixel effective age compensation component configured to receive a new frame rendering and to generate an adjusted frame rendering that compensates for luminance degradation of individual pixels based at least upon the stored pixel information.

2. The system of claim 1, wherein the stored pixel information includes additional parameters.

3. The system of claim 2, wherein the additional parameters include an operating temperature parameter and/or a mechanical stress parameter.

4. The system of claim 1, wherein the multiple color LEDs comprise at least a first color diode, a second color diode, and a third color diode per pixel.

5. The system of claim 4, wherein the first color diode comprises a red diode, the second color diode comprises a green diode, and the third color diode comprises a blue diode and wherein the stored pixel information reflects time parameter values and intensity parameter values for the red diode, the green diode, and the blue diode of the individual pixels.

6. The system of claim 5, further comprising luminance degradation profiles for the red diodes, the green diodes, and the blue diodes stored on the storage.

7. The system of claim 6, wherein the pixel effective age compensation component is configured to predict the luminance degradation for each color LED of each pixel from the stored pixel information.

8. The system of claim 7, wherein the pixel effective age compensation component is configured to calculate the adjusted frame rendering from the predicted luminance degradation of an individual color LED of an individual pixel and the respective luminance degradation profile for the color of the individual color LED.

9. The system of claim 1, further comprising a display interface and wherein the pixel effective age compensation component is configured to send the adjusted frame rendering to the display interface rather than the new frame rendering.

10. The system of claim 1, manifest as a single device or wherein the display is mounted in a housing of a first device and the processor, storage, pixel run time counter, and pixel effective age compensation components are embodied on a second device that is communicatively coupled to the first device.

11. A computer implemented process, comprising:
receiving a first frame rendering comprising first color intensity values for individual pixels of the first frame rendering;
storing the first color intensity values for the individual pixels;
receiving a second frame rendering comprising second color intensity values for the individual pixels of the second frame rendering;
updating the stored color intensity values for the individual pixels to reflect both the first color intensity values of the first frame rendering and the second color intensity values of the second frame rendering.

12. The computer implemented process of claim 11, wherein the stored color intensity values comprise a red color intensity value, a green color intensity value, and a blue color intensity value for the individual pixels.

13. The computer implemented process of claim 11, wherein the first frame rendering and the second frame rendering are consecutive sequential frame renderings or wherein the first frame rendering and the second frame rendering are separated by intervening frame renderings that are not reflected in the stored color intensity values.

14. The computer implemented process of claim 11, further comprising identifying a predefined frame capture interval and selecting the second frame rendering that satisfies the frame capture interval relative to the first frame rendering.

15. The computer implemented process of claim 14, wherein the frame capture interval is based upon a time duration or a number of intervening frames between the first frame rendering and the second frame rendering.

16. The computer implemented process of claim 11, wherein the first color intensity values and the second color intensity values relate to an intensity parameter and wherein the storing and updating store pixel information relating to additional parameters.

17. The computer implemented process of claim 16, wherein the additional parameters relate to operating temperature experienced by the individual pixels and mechanical stresses experienced by the individual pixels.

18. A device implemented method, comprising:
receiving a frame rendering for an LED display, the frame rendering comprising color intensity values for individual pixels of the frame rendering;
accessing stored color intensity values of previous frame renderings, the stored color intensity values reflecting time and intensity parameters that the individual pixels have been driven in the previous frame renderings;
adjusting the color intensity values based upon the stored color intensity values to compensate for pixel degradation caused by the previous frame renderings driven on the individual pixels; and,
generating an updated frame rendering that reflects the adjusted color intensity values.

19. The device implemented method of claim 18, wherein individual pixels comprise at least a first color diode, a second color diode, and a third color diode per pixel wherein the first color diode comprises a red diode, the second color diode comprises a green diode, and the third color diode comprises a blue diode and wherein the color intensity values comprise a red color value for the red pixel, a green color value for the green pixel, and a blue color value for the blue pixel, and wherein the adjusting comprises adjusting the red color value based upon a red LED aging rate, adjusting the green color value based upon a green LED aging rate, and adjusting the blue color value based upon a blue LED aging rate.

20. The device implemented method of claim 18, further comprising driving the LED display with the updated frame rendering rather than the frame rendering.

21. A device implemented method, comprising:
receiving a frame rendering for an LED display, the frame rendering comprising values of a color intensity parameter for individual pixels of the frame rendering;
accessing stored pixel information that relates to multiple parameters including the color intensity parameter,
determining a relative age of the individual pixels based upon the multiple parameters;
adjusting the color intensity values based upon pixel degradation associated with the relative age of the individual pixels; and,
generating an updated frame rendering that reflects the adjusted color intensity values.

22. The device implemented method of claim 21, wherein the determining comprises determining the relative age utilizing the color intensity parameter and at least one other parameter of the multiple parameters, including time of illumination, operating temperature, or mechanical stress.

23. The device implemented method of claim 21, wherein the determining comprises determining the relative age of individual LEDs within the individual pixels.

24. The device implemented method of claim 21, wherein the adjusting is also based upon user input.

25. A system, comprising:
a processor and memory available to the processor, the processor configured to:
convert image data into frame renderings for multiple pixels;
store pixel information on the storage that reflects time and intensity parameters that the frame renderings have driven an LED of at least one of the multiple pixels in the frame renderings; and,
generate an adjusted frame rendering that compensates for luminance degradation of the LED based at least upon the stored pixel information.

26. The system of claim 25, manifest on a single device.

27. The system of claim 26, wherein the single device also includes a display upon which the processor presents the adjusted frame rendering.

28. A display device, comprising:
a display comprising multiple individually controllable pixels that comprise light emitting diodes (LEDs); and
an application specific integrated circuit configured to receive frame renderings for presentation on the display and further configured to store pixel information that reflects time and intensity parameters at which the frame renderings have driven an individual LED of at least one of the multiple individually controllable pixels in the frame renderings and further configured to generate an adjusted frame rendering that compensates for luminance degradation of the individual LED based at least upon the stored pixel information.

29. The display device of claim 28, manifest as a freestanding monitor or wherein the display device is integrated into a device that includes a processor configured to generate the frame renderings.
